(19) United States
(12) Patent Application Publication
(10) Pub. No.: US 2014/0251591 A1
(43) Pub. Date: Sep. 11, 2014

(54) COOLING SYSTEM

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: PENG ZHANG, Wuhan (CN); YU-LIN LIU, Wuhan (CN)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 14/054,894

(22) Filed: Oct. 16, 2013

(30) Foreign Application Priority Data
Mar. 11, 2013 (CN) 2013100761258

(51) Int. Cl. G05D 23/19

(52) U.S. Cl. CPC G05D 23/1928
USPC 165/288

(57) ABSTRACT

A cooling system includes a first detection module, a second detection module, a control module connected to the first detection module and the second detection module, and a fan connected to the control module. The first detection module is used to detect a first temperature value and input a first voltage value to the control module according to the first temperature value. The second detection module is used to detect a second temperature value and input a second voltage value to the control module according to the second temperature value. The control device is used to control the fan according to a difference value between the first voltage and the second voltage.

### BACKGROUND

1. Technical Field

The present disclosure relates to cooling systems, and more particularly to a cooling system for an automatic vending machine.

2. Description of Related Art

Automatic vending machines allow customers to buy product twenty four hours a day. The automatic vending machine often comprises a cooling device and a fan located in a bottom portion of the automatic vending machine. The cool air generated by the cooling device is transmitted to the interior of the automatic vending machine by the fan. The bottom portion of the automatic vending machine can be effectively cooled by the fan, but other portions, such as the top portion of the automatic vending machine, cannot be effectively cooled by the fan. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like-reference numerals designate corresponding parts throughout the several views.

FIG. 1 is a schematic view of a cooling system in accordance with an embodiment.

FIG. 2 is a schematic view of a power supply module of the cooling system of FIG. 1.

FIG. 3 is a schematic view of a detecting module of the cooling system of FIG. 1.

FIG. 4 is a schematic view of a control module of the cooling system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

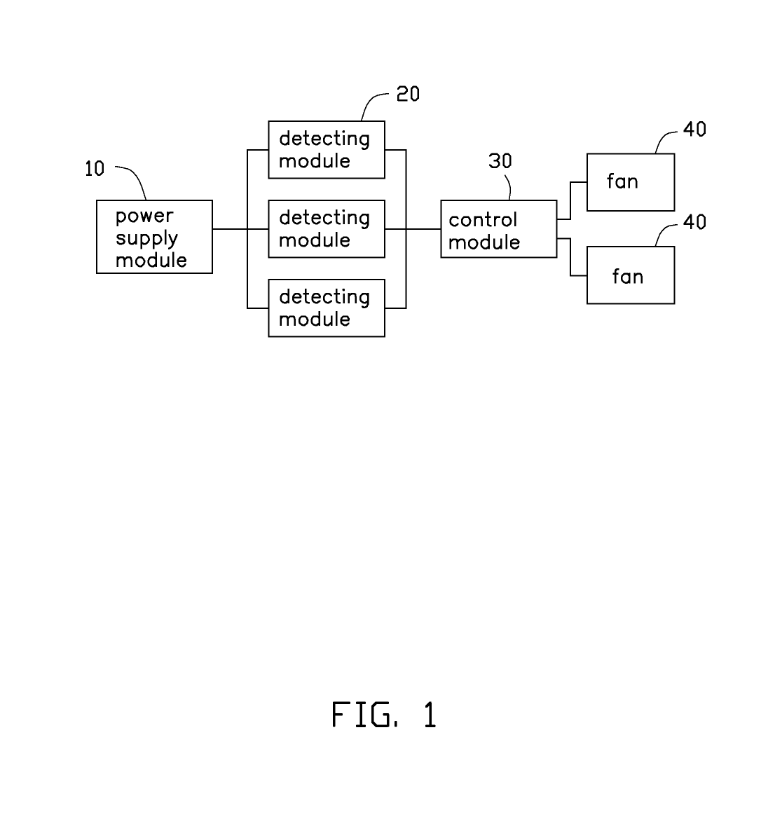

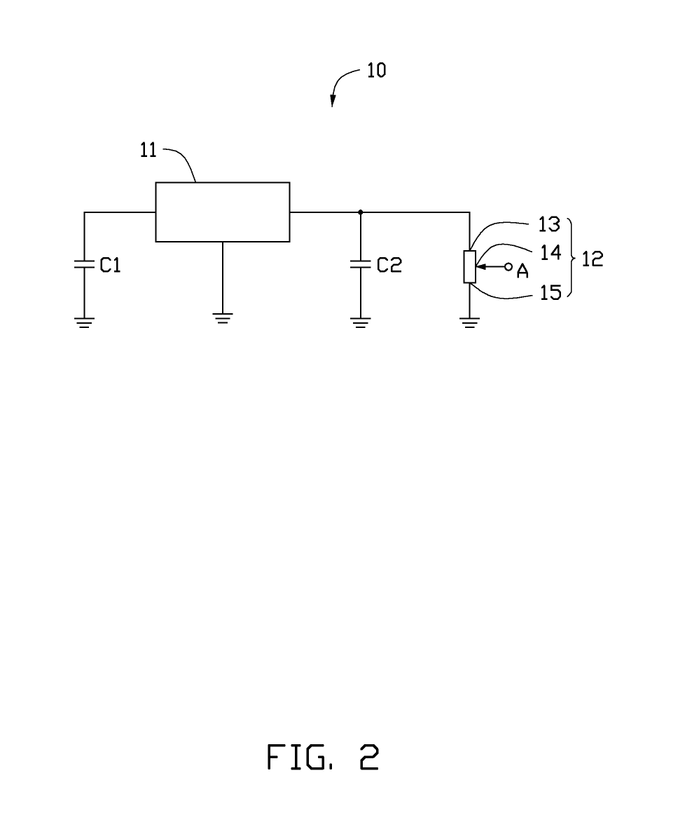

FIGS. 1-2 illustrate a cooling system in accordance with an embodiment. The cooling system comprises a power supply module 10, three detection modules 20, a control module 30, and two fans 40. The three detection modules 20 are connected to the power supply module 10 and the control module 30, and the two fans 40 are connected to the control module 30. In one embodiment, the three detection modules 20 are located on different locations of a vending machine and the two fans 40 are also located on different locations of the vending machine. a first one of the three detecting modules 20 is located on a top portion of the vending mechanism, a second one of the three detecting modules 20 is located on a middle portion of the vending mechanism, and a third one of the three detecting modules 20 is located on a bottom portion of the vending mechanism.

The power supply module 10 comprises a first capacitor C1, a second capacitor C2, a power source 11, and a first sliding rheostat 12. The first sliding rheostat 12 comprises a first connecting end 13, a second connecting end 15, and a first sliding end 14 located between the first connecting end 13 and the second connecting end 15. A terminal of the power source 11 is connected to a power supply (not shown), and the power source 11 is grounded via the first capacitor C1 and the second capacitor C2. The first end 13 is connected to the output end of the power source 11, and the second end 15 is grounded. The first sliding end 14 is connected to the three detection modules 20. In one embodiment, the resistance of the first sliding rheostat 12 is 0˜1 KΩ, the capacitance of the first capacitor C1 is 1 Uf and substantially equal to the capacitance of the second capacitor C2, and the model of the power source 11 is 78L05A.

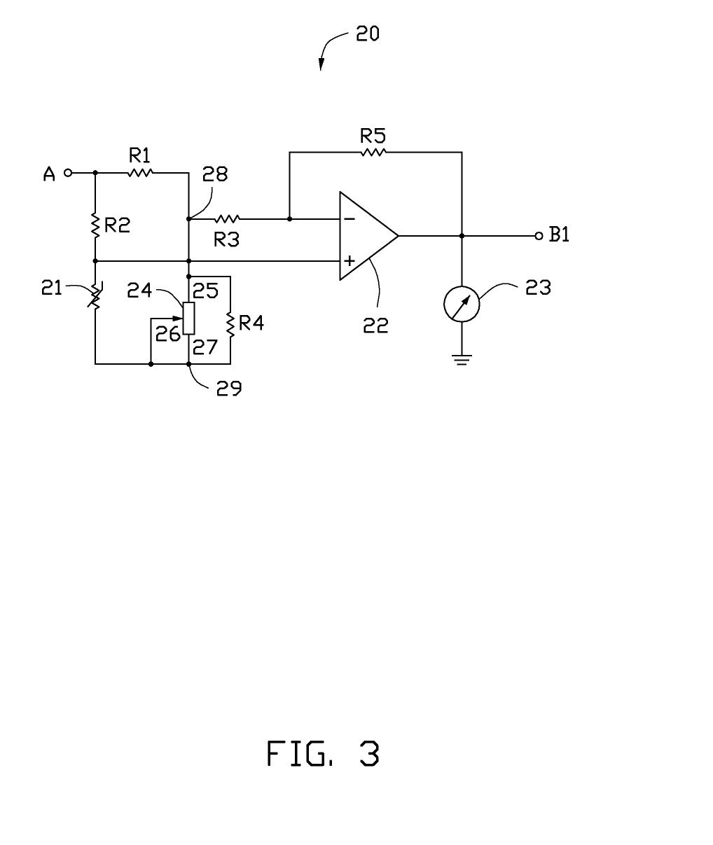

FIG. 3 illustrates each detection module 20 of the cooling system in accordance with an embodiment. Each detection module 20 comprises a sensor 21, an operational amplifier 22, a display 23, and a second sliding rheostat 24. The first sliding end 14 is connected to a first node 28 via a first resistor R1, and the first sliding end 14 is also connected to a positive terminal of the operational amplifier 22 via a second resistor R2. The first node 28 is connected to a negative terminal of the operational amplifier 22 via a third resistor R3. A first end of the sensor 21 is connected to the positive terminal of the operational amplifier 22, and a second end of the sensor 21 is connected to a second node 29.

The second sliding rheostat 24 comprises a third connecting end 25, a fourth connecting end 27, and a second sliding end 26 located between the third connecting end 25 and the fourth connecting end 26. The third connecting end 25 is connected to the first node 28, and the fourth connecting end 27 and the second sliding end 26 are connected to the second node 29. A fourth resistor R4 is connected to the first node 28 and the second node 29. The negative terminal of the operational amplifier 22 is connected to the control module 30 and also connected to the output end of the operational amplifier 22 via a fifth resistor R5. The operational amplifier 22 is connected to the display 23. In one embodiment, the sensor 21 is a temperature sensor, the resistance of the first resistor R1 is 560 kΩ and substantially equal to the resistance of the second resistor R2. The resistance of the third resistor R3 is 100 kΩ the resistance of the fourth resistor R4 is 1 kΩ, and the resistance of the fifth resistor R5 is 1 MΩ.

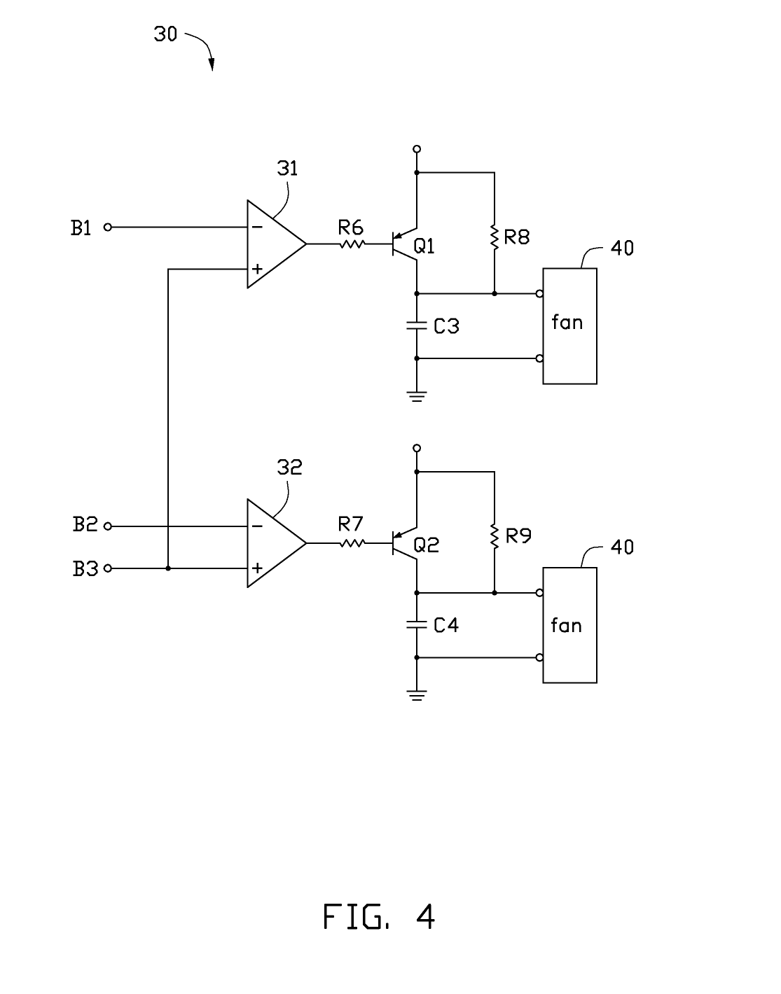

FIG. 4 illustrates the control module 30 of the cooling system in accordance with an embodiment. The control module 30 comprises a first comparator 31, a second comparator 32, a first transistor Q1, and a second transistor Q2. A first one of the three detecting modules 20 is connected to the negative terminal of the first comparator 31. A second one of the three detecting modules 20 is connected to the negative terminal of the second comparator 32. A third one of the three detection modules 20 is connected to the positive terminal of the first comparator 31 and the positive terminal of the second comparator 31. A base of the first transistor Q1 is connected to the first comparator 31 via a sixth resistor R6, and an emitter of the first transistor Q1 is connected to a power supply (not shown). The emitter of the first transistor Q1 is also connected to a positive pin of a first one of the two fans 40, and a collector of the first transistor Q1 is grounded via a third capacitor C3. A negative pin of the first one of the two fans 40 is grounded. A base of the second transistor Q2 is connected to the second comparator 32 via a seventh resistor R7, and an emitter of the second transistor Q2 is connected to a power supply (not shown). The emitter of the second transistor Q2 is also connected to a positive pin of a second one of the two fans 40, and a collector of the second transistor Q2 is grounded via a fourth capacitor C4. A negative pin of the second one of the two fans 40 is grounded. In one embodiment, the model of the first and second transistors Q1, Q2 are SSM2135S.

In use, the power supply module 10 offers a stable voltage U0 to the three detection modules 20. The first sliding end 14 is slid to change the resistance of the first sliding rheostat 12. Then, the stable voltage U0 of the three detection modules 20 is changed to a voltage U1 via the sliding rheostat 12 and the first and third resistors R1, R3, and inputted to the negative terminal of the operational amplifier 22. In addition, the stable voltage U0 of the sensor 21 is changed to a voltage U2 according to the temperature to input to the positive terminal of the operational amplifier 22. The voltage U1, U2 are changed to a voltage U3 by the operational amplifier 22 and is displayed as a temperature value by the display 23. The voltage U3 of the three detection modules 20 are inputted into the control module 30. The voltage U3 of the first one of the three detection modules 20 is compared with the voltage U3 of the third one of the three detection modules 20 via the first comparator 31 to generate a voltage U4. Then, the control module 30 controls the first one of the two fans 40 according to the voltage U4 and a voltage range Uref. For example, if the voltage U4 is in the voltage range Uref, the control module 30 starts the first one of the two fans 40; and if the voltage U4 is out of the voltage range Uref, the control module 30 stops the first one of the two fans 40. Similarly, the voltage U3 of the second one of the three detection modules 20 is compared with the voltage U3 of the third one of the three detection modules 20 via the second comparator 31 to generate a voltage U5. Then, the control module 30 controls the second one of the two fans 40 according to the voltage U5 and a voltage range Uref. For example, if the voltage U5 is in the voltage range Uref, the control module 30 starts the second one of the two fans 40; and if the voltage U5 is out of the voltage range Uref, the control module 30 stops the second one of the two fans 40.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A cooling system comprising:
a first detecting module;
a second detecting module;
a control module connected to the first detecting module and the second detecting module; and
a fan connected to the control module;
wherein the first detecting module is configured to detect a first temperature value and input a first voltage value to the control module according to the first temperature value; the second detecting module is configured to detect a second temperature value and input a second voltage value to the control module according to the second temperature value; and the controlling device is configured to open or close the fan according to a difference value between the first voltage and the second voltage.

2. The cooling system of claim 1, further comprising a power supply module; wherein the first detecting module comprises a sensor and an operational amplifier connected to the control module; a negative terminal of the operational amplifier is connected to a first node via a first resistor, and the first node is connected to the power supply module via a second resistor; the negative terminal of the operational amplifier is connected to the power supply module via a third resistor, the first node is connected to a second node via a fourth resistor, and the sensor is connected to the operational amplifier and the second node.

3. The cooling system of claim 2, wherein the power supply module comprises a power source and a first sliding rheostat; the first sliding rheostat comprises a first connecting end, a second connecting end, and a first sliding end; an input end of the power source is grounded via a first capacitor, an output end of the power source is grounded via a second capacitor and also connected to the first connecting end, the second connecting is grounded, and the sliding end is connected to the first detecting module.

4. The cooling system of claim 2, wherein the first detecting module further comprises a second sliding rheostat; the second sliding rheostat comprises a third connecting end, a fourth connecting end, and a second sliding end; the third connecting end is connected to the first node, and the fourth connecting end and a second sliding end are connected to the second node.

5. The cooling system of claim 2, wherein the first detecting module further comprises a display, and the operational amplifier is grounded by the display.

6. The cooling system of claim 2, wherein the negative terminal of the operational amplifier is connected to an output end of the operational amplifier via a fifth resistor.

7. The cooling system of claim 2, wherein the control module comprises a comparator and a transistor, an input end of the comparator is connected to the first detecting module and the second detecting module; and an output end of the comparator is connected to the base of the transistor via a sixth resistor.

8. The cooling system of claim 7, wherein an emitter of the transistor is connected to a power supply, a collector of the transistor is grounded via a third capacitor and also connected to a positive pin of the fan, and a negative pin of the fan is grounded.

9. The cooling system of claim 7, wherein the collector of the transistor is connected to the positive pin of the fan via a seventh resistor.

10. A cooling system comprising:
a first detecting module;
a second detecting module;
a third detecting module;
a control module connected to the first detecting module and the second detecting module;
a first fan connected to the control module; and
a second fan connected to the control module;
wherein the first detecting module is configured to detect a first temperature value and input a first voltage value to the control module according to the first temperature value; the second detecting module is configured to detect a second temperature value and input a second voltage value to the control module according to the second temperature value; the third detecting module is configured to detect a third temperature value and input a third voltage value to the control module according to the third temperature value; the control module is configured to close or open the first fan according to a difference value between the first voltage and the second voltage, and the control module is also configured to close or open the second fan according to a difference value between the second voltage and the third voltage.

11. The cooling system of claim 10, further comprising a power supply module; wherein the first detecting module comprises an operational amplifier connected to the control module; a negative terminal of the operational amplifier is connected to a first node via a first resistor, and the first node is connected to the power supply module via a second resistor; and the negative terminal of the operational amplifier is connected to the power supply module via a third resistor, the first node is connected to a second node via a fourth resistor.

12. The cooling system of claim 11, wherein the first detecting module further comprises a sensor, and the sensor is connected to the operational amplifier and the second node.

13. The cooling system of claim 12, wherein the power supply module comprises a power source and a first sliding rheostat; the first sliding rheostat comprises a first connecting end, a second connecting end, and a first sliding end; an input end of the power source is grounded via a first capacitor, an output end of the power source is grounded via a second capacitor and also connected to the first connecting end, the second connecting end is grounded, and the sliding end is connected to the first detecting module.

14. The cooling system of claim 12, wherein the first detecting module further comprises a second sliding rheostat; the second sliding rheostat comprises a third connecting end, a fourth connecting end, and a second sliding end; the third connecting end is connected to the first node, and the fourth connecting end and the second sliding end are connected to the second node.

15. The cooling system of claim 12, wherein the first detecting module further comprises a display, and the operational amplifier is grounded by the display.

16. The cooling system of claim 12, wherein the negative terminal of the operational amplifier is connected to an output end of the operational amplifier via a fifth resistor.

17. The cooling system of claim 11, wherein the control module comprises a first comparator and a first transistor, an input end of the first comparator is connected to the first detecting module and the second detecting module; and an output end of the first comparator is connected to the base of the first transistor via a sixth resistor.

18. The cooling system of claim 17, wherein an emitter of the first transistor is connected to a power supply, a collector of the first transistor is grounded via a third capacitor and also connected to a positive pin of the first fan, and a negative pin of the first fan is grounded.

19. The cooling system of claim 17, wherein the collector of the first transistor is connected to the positive pin of the first fan via a seventh resistor.
